(19) United States
(12) Patent Application Publication
(10) Pub. No.: US 2008/0311387 A1
(43) Pub. Date: Dec. 18, 2008

(54) Corrosion Resistant Object Having an Outer Layer of a Ceramic Material

(75) Inventors: Bo Gillesberg, Augustenborg (DK); Erik Christensen, Kgs. Lyngby (DK); Hans Joergen Pedersen, Ilsfeld (DE)

Correspondence Address: MCCORMICK, PAULDING & HUBER LLP, CITY PLACE II, 185 ASYLUM STREET, HARTFORD, CT, 06103, US

(73) Assignee: DANFOSS A/S, Nordborg (DK)

(21) Appl. No.: 11/917,213

(22) PCT Filed: Jun. 14, 2006
(86) PCT No.: PCT/DK06/00342

§ 371 Date: Jul. 3, 2008

(30) Foreign Application Priority Data
Jun. 15, 2005 (DK) PA200500876

(51) Int. Cl. B32B 9/00; B05D 5/12

(52) U.S. Cl. 428/332; 427/126.2; 428/472

(57) ABSTRACT

An object comprising an electrically conductive body part, e.g. comprising copper or silver, and a layer comprising a refractory metal, preferably tantalum. At least part of the refractory metal layer has been transformed into an electrically conductive ceramic material, preferably a tantalum boride. The refractory metal layer improves the corrosion resistant properties of the object and the ceramic material prevents oxidation of the refractory metal layer, and thereby passivation of the object during conduction of a current. The object is suitable for use as an electrode in corrosive environments. The object is cost effective because passivation can be avoided without applying a layer of precious metal. Also a method of forming the object in which the ceramic material is preferably provided by applying boride in a gaseous or solid phase and heating the object.

### CROSS REFERENCE TO RELATED APPLICATIONS

This application is entitled to the benefit of and incorporates by reference essential subject matter disclosed in International Patent Application No. PCT/DK2006/000342 filed on Jun. 14, 2006 and Danish Patent Application No. PA 2005 00876 filed Jun. 15, 2005.

### FIELD OF THE INVENTION

The present invention relates to an object which on the one hand is resistant towards corrosion, and on the other hand is electrically conductive. Furthermore, the present invention relates to a method for manufacturing such an object in manner which is cost effective without compromising the corrosion resistant or conductive properties of the object. An object according to the present invention may advantageously be applied as an electrode which is to be used in a corrosive environment.

### BACKGROUND OF THE INVENTION

For some purposes it is desirable to provide corrosion resistant surfaces which are electrically conductive. This is, e.g., relevant when manufacturing electrodes which are to be used in a hostile or aggressive medium, such as an acid, a base, ion containing environments, such as chloride, etc. At the present time such electrodes are typically either made from a precious metal, such as gold or platinum, or from a corrosion resistant material, such as tantalum, niobium, titanium, zirconium, etc., with an outer layer of a precious metal having a thickness of approximately 1 μm to 20 μm. The outer layer may be applied using an electrochemical reaction, e.g. a Degussa process, or it may be laminated onto the surface as a foil. These methods provide an electrically conductive surface, and a corrosion resistance which is determined by the material of the lower layer is obtained. The layer of precious metal is applied in order to prevent oxidation of the refractory metal during conduction of a current. Such oxidation is highly undesirable because it may lead to passivation of the surface of the object.

There are, however, situations where the methods described above are not applicable. Since precious metals are normally relatively expensive, the costs involved in manufacturing the electrode entirely from a precious metal or providing a layer of precious metal are sometimes considered too high.

### SUMMARY OF THE INVENTION

Thus, it is an object of the present invention to provide a corrosion resistant and electrically conductive object which is cost effective to manufacture.

It is a further object of the present invention to provide a corrosion resistant object having a relatively high electrical conductivity.

It is an even further object of the present invention to provide an electrode which may be used in corrosive environments, and which is cost effective to manufacture.

It is an even further object of the present invention to provide a method of manufacturing a corrosion resistant and electrically conductive object in a cost effective manner.

It is an even further object of the present invention to provide an object and a method of manufacturing the object in which the need for applying a precious metal layer is avoided without risking passivation of the object.

According to a first aspect of the invention the above and other objects are fulfilled by providing an object comprising:
an electrically conductive body part,
a layer at least substantially covering an outer surface of the body part, said layer comprising a refractory metal or an alloy of a refractory metal, and at least part of said layer comprising an electrically conductive ceramic material.

The body part is electrically conductive, i.e. it is capable of conducting an electrical current. Thereby the object will be electrically conductive, and the conductivity of the object will be determined by the material selected for the body part.

The object further comprises a layer comprising a refractory metal or an alloy of a refractory metal. Such materials are known to be corrosion resistant, and the layer therefore provides the desired corrosion resistant properties to the object.

Thus, a desired conductivity may be obtained by selecting an appropriate material for the body part, without taking the corrosion resistant properties of this material into account, because the object will be protected (in terms of corrosion) by the layer. Similarly, the material of the body part may be selected in accordance with other desired properties, such as heat conductivity, tensile strength, hardness, etc.

Due to the fact that at least part of the layer comprises an electrically conductive ceramic material, it is ensured that the outer surface of the object is electrically conductive. Furthermore, because the layer comprises a ceramic material, the refractory metal is prevented from oxidising, and thereby passivation of the object is prevented. This is thereby obtained without the need for a layer of precious metal, and the manufacturing costs may therefore be considerably reduced without jeopardising the corrosion resistant properties of the object.

The body part is preferably made from or comprises a metal or an alloy, such as copper, silver, titanium, or any other suitable kind of metal, or an alloy thereof.

In one embodiment the entire layer may comprise the ceramic material. Alternatively, the ceramic material may only be present in a part of the layer, preferably an outer part of the layer. In this case the boundary between a region of the layer in which the ceramic material is present and a region in which it is not present may be gradual in the sense that the density of the ceramic material may decrease gradually along a line through the layer from an outer surface towards the body part.

The ceramic material may be a boride of a refractory metal. Alternatively the ceramic material may be any other suitable electrically conductive ceramic material, such as a nitride or a carbide of a refractory metal.

The layer may comprise tantalum or an alloy of tantalum. Alternatively or additionally, it may comprise any other suitable refractory metal, such as niobium, titanium, zirconium, etc., and/or an alloy of any of these refractory metals.

In a preferred embodiment the layer comprises tantalum or an alloy of tantalum, and the ceramic material is tantalum boride, TaBₓ, preferably TaB₂. This is particularly advantageous because TaB₂ may have metallic conductivity (approximately 0.07×10⁶ Ω⁻¹cm⁻¹), and at the same time it is as corrosion resistant (at least in an acidic environment) as tantalum. The conductivity is obtained because boron atoms are built into tantalum crystals up until the composition TaB₂, where the metal structure is still maintained. Other possible tantalum compounds are TaB, Ta₂B and Ta₃B₄. TaB has a conductivity of 0.01×10⁶ Ω⁻¹cm⁻¹.

As mentioned above, the body part is preferably made from a metal or an alloy, in which case the layer may in one embodiment comprise an alloy of a refractory metal and a metal present in the body part. In this embodiment the first layer may be formed on the body part by applying the refractory metal in such a way that desired alloying takes place. Thereby the corrosion resistance of the object is improved. Furthermore, the amount of refractory metal needed in order to ensure the desired corrosion resistant properties may be lower than is the case when a separate layer is applied on top of the body part. For example, if the body part is made from titanium or an alloy of titanium, and if the refractory metal is tantalum, a titanium/tantalum alloy may be formed at the surface of the body part. In this case the amount of tantalum needed in order to provide a layer which is sufficiently corrosion resistant will be less than the amount needed if a separate layer of tantalum was to be applied to the body part.

In the embodiment described above, the layer of ceramic material may advantageously be formed by applying a non-metallic component, preferably boron. The boron will then react primarily with the refractory metal (preferably tantalum). This may result in a ceramic layer comprising the alloy of the refractory metal and the metal present in the body part, as well as the applied non-metallic component. In the example above, this would be titanium, tantalum and boron.

Alternatively, the ceramic layer may comprise a mixed oxide, i.e. an oxide of the alloy comprising the refractory metal and the metal present in the body part, e.g. a titanium/tantalum oxide. Such a layer will have a higher conductivity than a pure tantalum oxide layer, and this is desirable in case the object is to be used as an electrode.

The layer may have a thickness within the interval 0.1 μm to 200 μm, such as within the interval 0.5 μm to 100 μm, such as within the interval 1 μm to 20 μm, such as within the interval 5 μm to 100 μm. In any event the thickness of the layer should be sufficient to protect the body part from corrosion. The thickness of the layer may accordingly depend on the intended environment of use, the refractory metal present in the layer, and the exact material composition of the layer.

The body part may have a conductivity within the interval 0.01×10⁶ Ω⁻¹cm⁻¹ to 0.65×10⁶ Ω⁻¹cm⁻¹.

The object preferably is or forms part of an electrode. Due to the conductive and corrosion resistant properties of such an electrode, it will be very suitable for being used in a hostile and corrosive environment. Furthermore, as mentioned above, the manufacturing costs are considerably reduced relatively to prior art electrodes suitable for use in such environments.

According to a second aspect of the invention the above and other objects are fulfilled by providing a method of forming an object, the method comprising the steps of:
providing an electrically conductive body part,
applying a layer to a surface part of the body part, said layer comprising a refractory metal or an alloy of a refractory metal, and
processing said layer in such a way that at least part of said layer is transformed into an electrically conductive ceramic material.

It should be noted that the skilled person would readily recognise that any feature described in connection with the first aspect of the invention may also be combined with the second aspect of the invention, an vice versa.

As mentioned above, the processing of the layer in such a way that at least part of the layer is transformed into an electrically conductive ceramic material, ensures that the object has the desired corrosion resistant properties as well as desired conductive properties, and passivation of the object is prevented. Furthermore, these properties are obtained in a cost effective manner because the need for a layer of precious metal is avoided.

The processing step may comprise positioning the object in a gaseous atmosphere containing a desired element, in which case the ceramic material may be formed by a gaseous phase reaction between the refractory metal of the layer and the desired element.

Alternatively, the processing step may comprise applying a desired element in a solid phase, in which case the ceramic material may be formed by a solid phase reaction between the refractory metal of the layer and the desired element. In this embodiment a paste containing boron may be smeared onto the body part.

In a preferred embodiment the desired element is boron. In this case ceramic material may preferably be a tantalum boride, TaBₓ, as described above.

The body part may comprise a metal or an alloy. In this case the step of applying a layer to a surface part of the body part may be performed in such a way that the resulting layer comprises an alloy of a refractory metal and a metal present in the body part. This has already been described above.

The processing step may further comprise applying a non-metallic compound to the layer, thereby forming a ceramic material comprising the refractory metal, a metal present in the body part and the non-metallic compound. The non-metallic compound may preferably be oxygen, and in this case the ceramic material preferably comprises an oxide of the alloy of the refractory metal and the metal present in the body part, most preferably a titanium/tantalum oxide. This has already been described above. Alternatively or additionally such a layer may comprise nitrides and/or carbides of the mixed metal/refractory metal component and/or either the metal or the refractory metal.

The processing step may further comprise heating at least the layer to a temperature within the interval 300° C. to 1500° C., such as to a temperature within the interval 500° C. to 1500° C. The exact temperature will depend on the situation, in particular the choice of materials, whether one or more compounds is/are applied in a gaseous phase or in a solid phase, etc.

### BRIEF DESCRIPTION OF THE DRAWINGS

The invention will now be further described with reference to the accompanying drawings in which:

FIG. 1 shows an object according to an embodiment of the invention and comprising a body part,

FIG. 2 shows the object of FIG. 1 with a layer of refractory metal, and

FIG. 3 shows the object of FIGS. 1 and 2, where part of the refractory metal layer comprises a ceramic material.

### DETAILED DESCRIPTION OF THE DRAWINGS

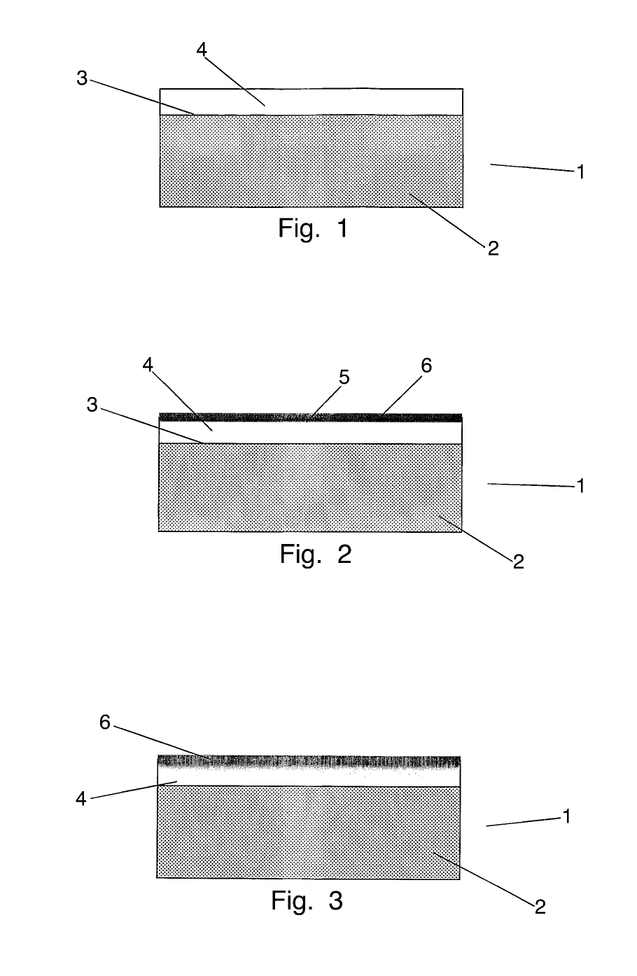

FIG. 1 shows an object 1 according to an embodiment of the present invention. The object 1 comprises an electrically conductive body part 2, e.g. being made from or comprising copper or silver.

FIG. 2 shows the object 1 of FIG. 1. In FIG. 2 an outer surface 3 of the body part 2 has been provided with a layer 4 comprising a refractory metal, preferably tantalum. The layer 4 is applied in order to improve the corrosion resistant properties of the object 1.

FIG. 3 shows the object 1 of FIGS. 1 and 2. In FIG. 3 the object 1 has been processed in such a way that an outer part 5 of the refractory metal layer 4 has been transformed into an electrically conductive ceramic material. The ceramic material 5 may advantageously be a tantalum boride, such as TaB₂. The ceramic material 5 prevents oxidation of the refractory metal layer 4, and thereby passivation of the object 1.

FIGS. 1-3 thereby illustrate a method of forming the object 1 in accordance with an embodiment of the invention. First the body part 2 is provided as illustrated in FIG. 1. Subsequently the refractory metal layer 4 is applied to the outer surface 3 of the body part 2 in order to provide the object 1 with desired corrosion resistant properties. This is illustrated in FIG. 2. Finally, the object 1 comprising the body part 2 with the refractory metal layer 4 formed thereon, is processed in order to transform at least the outer part of the refractory metal layer 4 into the ceramic material 5, thereby providing protection from oxidation to the refractory metal layer 4. This is illustrated in FIG. 3. The processing may advantageously be performed by applying boron in a gaseous phase, possibly in combination with oxygen, to the object 1 and heating the object 1 and the gas. Thereby a reaction will take place between tantalum present in the refractory metal layer 4 and boron present in the applied gas, and thereby TaB₂, which is an electrically conductive ceramic material, is formed in the layer 4. The resulting object 1 will be electrically conductive, corrosion resistant and protected from passivation. It will therefore be very suitable for use as an electrode in corrosive environments. Furthermore, material costs are reduced as compared to electrodes having a layer of precious metal in order to prevent passivation of the electrode when a current is conducted.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method of forming an object, the method comprising the steps of:
providing an electrically conductive body part,
applying a layer to a surface part of the body part, said layer comprising a refractory metal or an alloy of a refractory metal, and
processing said layer in such a way that at least part of said layer is transformed into an electrically conductive ceramic material.

2. The method according to claim 1, wherein the processing step comprises positioning the object in a gaseous atmosphere containing a desired element, and wherein the ceramic material is formed by a gaseous phase reaction between the refractory metal of the layer and the desired element.

3. The method according to claim 1, wherein the processing step comprises applying a desired element in a solid phase, and wherein the ceramic material is formed by a solid phase reaction between the refractory metal of the layer and the desired element.

4. The method according to claim 2, wherein the desired element is boron.

5. The method according to claim 1, wherein the body part comprises a metal or an alloy, and wherein the step of applying a layer to a surface part of the body part is performed in such a way that the resulting layer comprises an alloy of a refractory metal and a metal present in the body part.

6. The method according to claim 5, wherein the processing step comprises applying a non-metallic compound to the layer, thereby forming a ceramic material comprising the refractory metal, a metal present in the body part and the non-metallic compound.

7. The method according to claim 6, wherein the non-metallic compound is oxygen, and wherein the ceramic material comprises an oxide of the alloy of the refractory metal and the metal present in the body part.

8. The method according to claim 2, wherein the processing step further comprises heating at least the layer to a temperature within the interval 300° C. to 1500° C.

9. An object comprising:
an electrically conductive body part,
a layer at least substantially covering an outer surface of the body part, said layer comprising a refractory metal or an alloy of a refractory metal, and at least part of said layer comprising an electrically conductive ceramic material.

10. The object according to claim 9, wherein the entire layer comprises the ceramic material.

11. The object according to claim 9, wherein the ceramic material is a boride of a refractory metal.

12. The object according to claim 9, wherein the layer comprises tantalum or an alloy of tantalum.

13. The object according to claim 9, wherein the body part is made from a metal or an alloy, and wherein the layer comprises an alloy of a refractory metal and a metal present in the body part.

14. The object according to claim 9, wherein the layer has a thickness within the interval 0.1 μm to 200 μm.

15. The object according to claim 9, wherein the body part has a conductivity within the interval 0.01×10⁶ Ω⁻¹cm⁻¹ to 0.65×10⁶ Ω⁻¹cm⁻¹.

16. The object according to claim 9, wherein the object is or forms part of an electrode.
